(19) United States
(12) Patent Application Publication
(10) Pub. No.: US 2026/0110800 A1
(43) Pub. Date: Apr. 23, 2026

(54) METHOD FOR ESTIMATING LiDAR ODOMETRY AND COVARIANCE OF MOVING OBJECT USING NDT-PSO AND THE APPARATUS THEREOF

(71) Applicant: Twinny Co., Ltd., Daejeon (KR)

(72) Inventor: Jae Bong SONG, Daejeon (KR)

(73) Assignee: Twinny Co., Ltd., Daejeon (KR)

(21) Appl. No.: 19/152,439

(22) PCT Filed: May 19, 2025
(86) PCT No.: PCT/KR2025/006750

§ 371 Date: Jul. 30, 2025

(30) Foreign Application Priority Data
May 23, 2024 (KR) 10-2024-0067422

(51) Int. Cl. G01S 17/89; G01S 7/48; G01S 17/42; G01S 17/58; G01S 17/931

(52) U.S. Cl. CPC G01S 17/89; G01S 7/4808; G01S 17/42; G01S 17/58; G01S 17/931

(57) ABSTRACT

A method and a apparatus for expressing scan data detected by a LiDAR mounted on a moving object as a submap based on a Normal Distribution Transform (NDT) estimate a relative positional change (LiDAR odometry) of the moving object through scan matching using Particle Swarm Optimization (PSO) between the submap and real-time scan data, and determine a covariance of the estimated LiDAR odometry by recognizing the shape of the surrounding environment based on the orientation of normal distributions represented in the NDT-based submap.

### CROSS REFERENCE TO THE RELATED APPLICATIONS

This application is the national phase entry of International Application No. PCT/KR2025/006750, filed on May 19, 2025, which is based upon and claims priority to Korean Patent Application No. 10-2024-0067422, filed on May 23, 2024, the entire contents of which are incorporated herein by reference.

### TECHNICAL FIELD

The present invention relates to a method and an apparatus for estimating LiDAR odometry of a moving object using NDT-PSO and estimating a covariance of the LiDAR odometry.

### BACKGROUND

Accurate localization, which enables a mobile robot to recognize its own position, is an essential technology for the autonomous driving of the mobile robot.

For localization or map building (SLAM), the mobile robot must be able to accurately estimate its relative positional changes in real time. Various sensors such as an inertial sensor (IMU: inertial measurement unit), a wheel encoder, a LiDAR, and a camera are used to measure or calculate relative positional changes of a mobile robot. Among these, a LiDAR (Light Detection and Ranging) is a sensor that emits laser pulses to the surroundings of a mobile robot and records the time it takes for the reflected signals to return in order to measure the distances to surrounding objects. The process of indirectly estimating the movement of the mobile robot based on changes in the distances to surrounding objects measured using the LiDAR is referred to as LiDAR odometry.

To calculate LiDAR odometry based on two scan data sets obtained at different times from two LiDARs mounted at different positions on a mobile robot, a transformation that aligns the two scan data sets must be acquired, which is referred to as scan registration or scan matching. Among various scan matching methods, Normal Distribution Transform (NDT) is a method in which the reference scan data for the transformation is projected onto a virtual grid, and the scan data within each grid cell is modeled as a normal distribution. A transformation is then arbitrarily applied to the scan data, and the distances to the set of normal distributions are calculated to obtain a transformation that minimizes the total distance.

In the conventional NDT method, a gradient-based Newton method is used to obtain an optimal transformation between the set of normal distributions represented by NDT and the scan data. However, this method has the disadvantage that the result may converge to a local optimum depending on the initial value during optimization, and it imposes a high computational burden. In addition, LiDAR odometry may exhibit degraded performance in environments such as long corridors, where it is difficult to identify changes in distances to surrounding objects using LiDAR.

### RELATED ART DOCUMENT

### Non-Patent Document

(Non-Patent Document 1) Valencia, Rafael, et al. “Localization in highly dynamic environments using dual-timescale NDT-MCL.” 2014 IEEE international conference on robotics and automation (ICRA). IEEE, 2014.

### SUMMARY

The problem to be solved by the present invention is to introduce a Particle Swarm Optimization (PSO) method, instead of a conventional optimization approach, into the NDT (Normal Distribution Transform) scan matching process, thereby reducing the influence of initial values on the optimization result and calculating a solution close to the global optimum to provide accurate LiDAR odometry.

Another problem to be solved by the present invention is to model the surrounding environment of a moving object based on scan data represented using the NDT method, and to determine and provide the covariance of the estimated LiDAR odometry in environments with less geometric structure, where the performance of LiDAR odometry may degrade.

However, the technical problems to be solved by the present invention are not limited to the above-mentioned problems, and may be variously extended without departing from the technical spirit and scope of the present invention.

According to an embodiment of the present invention, a method for estimating LiDAR odometry and covariance of a moving object, performed by a computer, includes: constructing a two-dimensional (2D) Normal Distribution Transform (NDT) submap by applying NDT to a 2D submap; estimating LiDAR odometry of the moving object using the 2D NDT submap; and calculating at least one eigenvector of a normal distribution of a grid within the 2D NDT submap, extracting a grid having an eigenvector corresponding to a real-time pose of the moving object, and determining a covariance of the LiDAR odometry.

According to an embodiment of the present invention, an apparatus for estimating LiDAR odometry and covariance of a moving object includes: a submap module configured to construct a two-dimensional (2D) Normal Distribution Transform (NDT) submap by applying NDT to a 2D submap; a LiDAR Odometry estimation module configured to estimate LiDAR odometry of the moving object using the 2D NDT submap; and a covariance determination module configured to calculate at least one eigenvector of a normal distribution of a grid within the 2D NDT submap, extract a grid having an eigenvector corresponding to a real-time pose of the moving object, and determine a covariance of the LiDAR odometry.

According to an embodiment of the present invention, by representing scan data detected by a moving object including a two-dimensional LiDAR as a two-dimensional (2D) Normal Distribution Transform (NDT) submap, it is possible to quickly obtain a global optimum through scan matching based on Particle Swarm Optimization (PSO) between the real-time collected scan data and the NDT submap.

According to an embodiment of the present invention, by identifying the geometric characteristics of the surrounding environment through the eigenvectors of the set of normal distributions in the NDT submap, it is possible to determine the covariance of the estimated LiDAR odometry.

According to an embodiment of the present invention, since two-dimensional (2D) LiDAR odometry can be obtained, it is possible to provide a pose estimation function that is more accurate and adaptable to various situations by utilizing diverse odometry sources.

According to an embodiment of the present invention, by proposing an algorithm for NDT-based short-term mapping using a predetermined number of LiDAR keyframes, it is possible to perform two-dimensional position estimation with reduced influence from dynamic obstacles through pose estimation.

According to an embodiment of the present invention, it is possible to secure an algorithm required for extension to NDT-MCL, which provides improved position accuracy compared to conventional AMCL-based localization, and to establish a data structure that allows speed improvement through parallelization.

However, the effects of the present invention are not limited to the above-mentioned effects and may be variously extended without departing from the technical spirit and scope of the present invention.

### BRIEF DESCRIPTION OF THE DRAWINGS

FIG. 1 illustrates a flowchart of a method for estimating LiDAR odometry and covariance of a moving object according to an exemplary embodiment of the present invention.

FIGS. 2 to 7 are diagrams provided to describe respective steps of a method for estimating LiDAR odometry and covariance of a moving object according to an exemplary embodiment of the present invention.

FIG. 8 is a block diagram illustrating a detailed configuration of an apparatus for estimating LiDAR odometry and covariance of a moving object according to an exemplary embodiment of the present invention.

### DETAILED DESCRIPTION OF THE EMBODIMENTS

Advantages and features of the present invention, and a method of achieving them will be apparent with reference to the embodiments described below in detail together with the accompanying drawings. However, the present invention is not limited to the embodiments disclosed below, and may be embodied in various forms. Rather, the description of the embodiments of the present invention is provided so that this disclosure will be thorough and complete and will fully convey the concept of the invention to those of ordinary skill in the art. Accordingly, the present invention is only defined by the scope of the appended claims.

The terms used in this specification are for the purpose of describing embodiments only and are not intended to limit the present invention. In this specification, the singular forms “a,” “an,” and “the” also include the plural forms unless otherwise specifically specified in the phrase. As used herein, the terms “comprises” and/or “comprising” do not exclude the presence or addition of one or more other components, steps, operations, and/or elements in addition to the components, steps, operations, and/or elements mentioned.

Unless otherwise defined, all terms (including technical and scientific terms) used in this specification will be used as meanings that can be commonly understood by those of ordinary skill in the art. In addition, terms defined in a commonly used dictionary are not interpreted ideally or excessively unless explicitly and specifically defined.

Hereinafter, preferred embodiments of the present invention will be described in more detail with reference to the accompanying drawings. The same reference numerals are used for the same components in the drawings, and repeated descriptions of the same components will be omitted.

Hereinafter, methods and apparatuses for estimating LiDAR odometry and covariance of a moving object using NDT-PSO will be described (hereinafter collectively referred to as a method and an apparatus for estimating LiDAR odometry and covariance of a moving object). The method for estimating LiDAR odometry and covariance of a moving object may be performed by an apparatus for estimating LiDAR odometry and covariance of a moving object, which is a computer apparatus including a processor, and the apparatus for estimating LiDAR odometry and covariance of a moving object may be operated under the control of a computer program. The above-described computer program may be stored in a computer-readable recording medium in conjunction with a computer apparatus to execute a hologram content processing method on the computer apparatus. The computer program described herein may take the form of a standalone program package, or may take the form of a program package that is pre-installed on a computer apparatus and operates in conjunction with an operating system or other program packages.

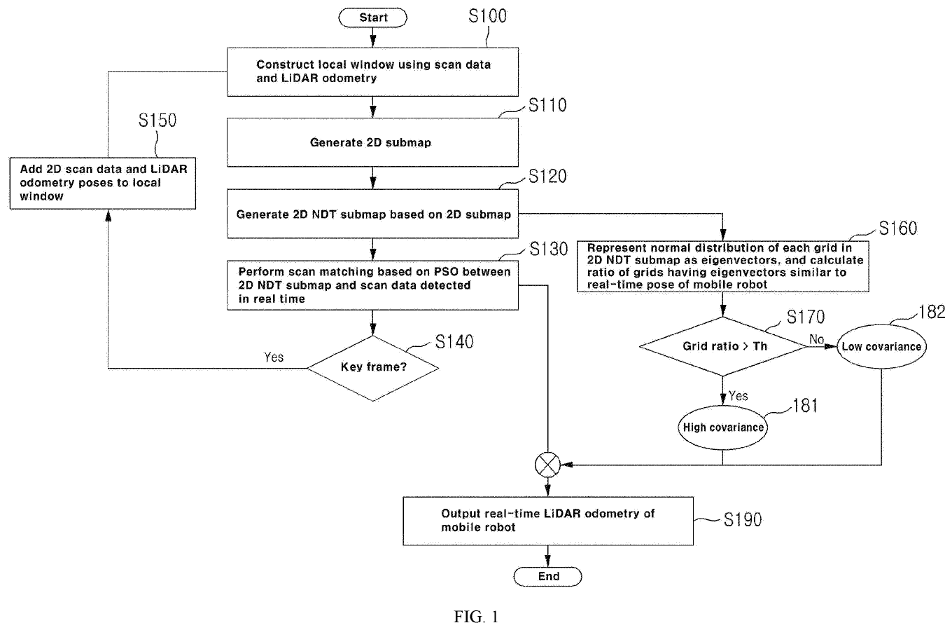

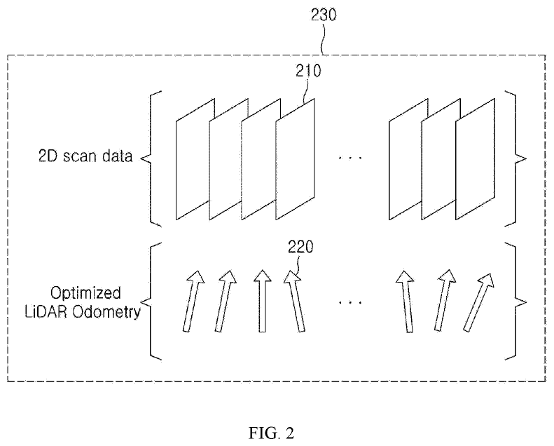

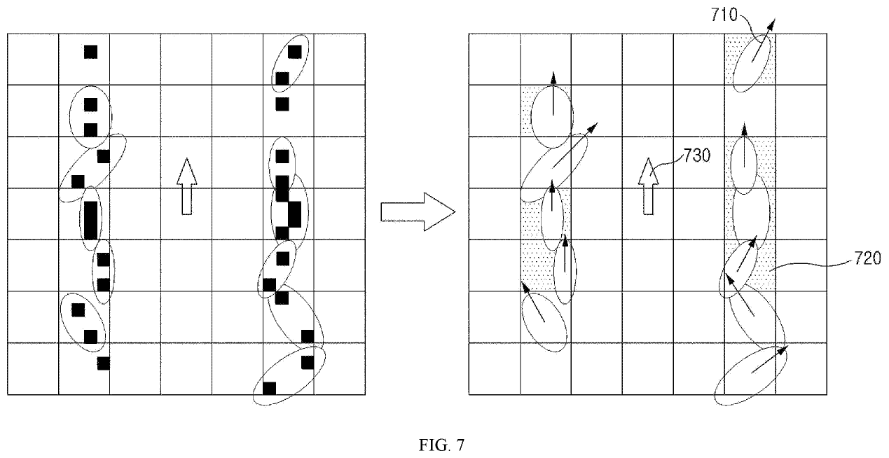

FIG. 1 illustrates a flowchart of a method for estimating LiDAR odometry and covariance of a moving object 20 according to an exemplary embodiment of the present invention. In addition, FIGS. 2 to 7 are diagrams provided to describe respective steps of a method for estimating LiDAR odometry and covariance of a moving object 20 according to an exemplary embodiment of the present invention.

The moving object 20 may be a system that detects surrounding objects and moves in response to the surrounding terrain. For example, the moving object 20 may be any one of a robot, a vehicle, a drone, an unmanned transport vehicle, a delivery robot, a service robot, and a cleaning robot, but is not limited thereto.

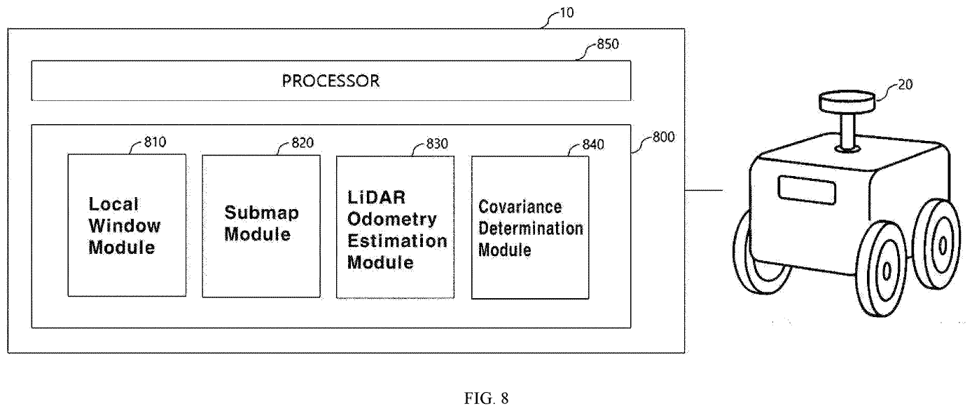

The method of FIG. 1 is performed by an apparatus 10 for estimating LiDAR odometry and covariance of a moving object 20 according to an exemplary embodiment of the present invention, as illustrated in FIG. 8.

Referring to FIG. 1, in step S100, an apparatus 10 for estimating LiDAR odometry and covariance of a moving object 20 according to an exemplary embodiment of the present invention (more precisely, a local window module 810 of the apparatus 10 for estimating LiDAR odometry and covariance of the moving object 20) constructs a local window using scan data detected by a LiDAR mounted on the moving object 20 and LiDAR odometry.

The local window is defined as a set of scan data and LiDAR odometry accumulated in a preset number. Here, the LiDAR odometry may include pose information (x, y, θ) of the moving object. For example, referring to FIG. 2, the local window module 810 selects keyframes from among the scan data and stores them in a preset number. In addition, the local window module 810 stores the LiDAR odometry corresponding to each of the keyframes in the same number.

The LiDAR odometry may include information on the position of the moving object 20 and its current heading direction in a space defined as a 2D sub-map. In the case where the moving object 20 employs a mecanum wheel drive system, the LiDAR odometry may be defined to include information such as the last moving direction and a time-averaged recent moving direction.

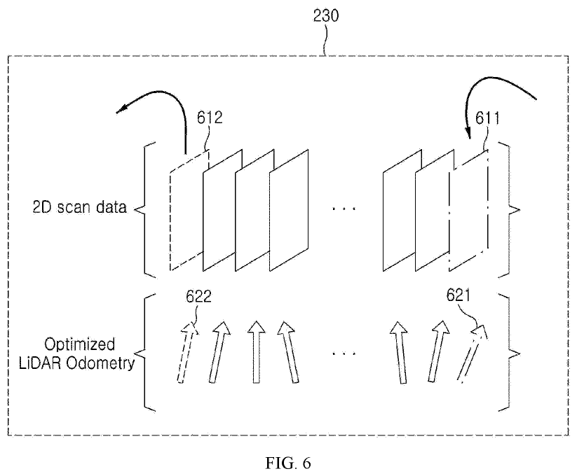

The local window module 810 may update a portion of the data, as illustrated in FIG. 6. In this case, the total number of keyframes and the corresponding number of LiDAR odometry data are maintained. The moving object 20 (or an autonomous driving robot) is equipped with at least one LiDAR, and LiDARs mounted at different positions on the moving object 20 detect scan data.

In this case, the LiDAR may be a radar system that emits laser pulses toward a reflector (or target object), measures the time taken for the pulses to be reflected and return from the reflector, and determines the position coordinates of the reflector based on the measured time. As is well known, the LiDAR stores position coordinates calculated from reflection intensity as measurement data (or scan data), and the measurement data may be used as basic information for visualizing a 3D graph structure. In this case, since the LiDAR is a device that is already widely used in the relevant technical field, a detailed description of its structure and operating principle will be omitted.

In addition, LiDAR odometry represents the result of estimating the displacement of the LiDAR or the moving object 20 on which the LiDAR is mounted, based on changes in the LiDAR scan data.

In step S100, the apparatus of the present invention may construct a local window by combining scan data of a preset number of keyframes among scan data detected by the LiDAR mounted on the moving object 20 with LiDAR odometry at each point in time from the scan data of the keyframes. Here, the scan data may be 2D scan data.

More specifically, referring to FIG. 2, a plurality of scan data 210 is detected by the LiDAR mounted on the moving object 20. Among the plurality of scan data, scan data 210 corresponding to a preset number of most recent keyframes may be extracted, and LiDAR odometry 220 at each point in time may be combined and stored with the scan data to construct a local window 230. In FIG. 2, the scan data 210 represents scan data corresponding to a preset number of most recent keyframes, and the LiDAR odometry 220 represents the LiDAR odometry at each point in time of the scan data corresponding to the keyframes. Here, the preset number is not limited.

A keyframe refers to a frame selected from LiDAR or camera data that contains information meaningful for subsequent computations, and the criteria for selecting keyframes may be based on fixed time intervals, fixed odometry changes, or every scan data. Accordingly, when an appropriate keyframe selection method is chosen, in step S100, the apparatus of the present invention may extract and store scan data corresponding to a preset number of keyframes based on the selected method, and store the LiDAR odometry at each point in time to construct a local window.

In step S110, the apparatus 10 for estimating LiDAR odometry and covariance of the moving object 20 according to an exemplary embodiment of the present invention (more precisely, a submap module 820 of the apparatus 10 for estimating LiDAR odometry and covariance of the moving object 20) generates a 2D submap using the local window.

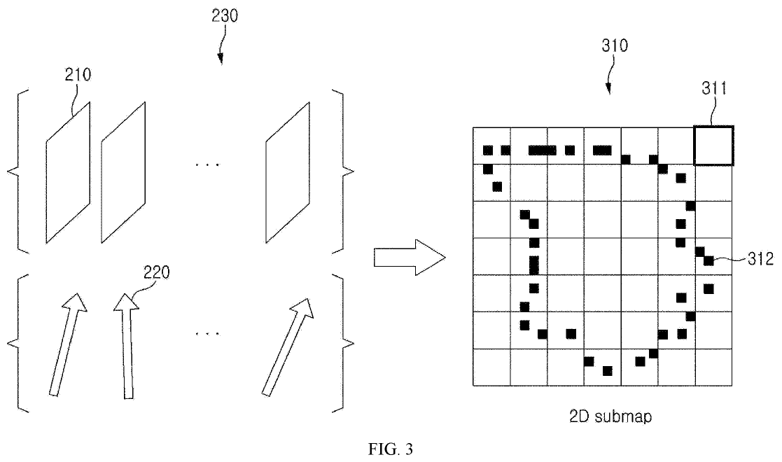

In step S110, the apparatus of the present invention may generate a 2D submap by fusing the scan data and LiDAR odometry of the local window. More specifically, referring to FIG. 3, in step S110, the apparatus of the present invention may generate a 2D submap 310 by projecting the accumulated information of the scan data 210 within the local window 230 onto a grid 311. The grid 311 is a region set within the 2D submap 310 and may serve as a reference for the range of a data set used to calculate covariance.

When the 2D submap 310 is generated for the first time, since there is no basic information for estimating the LiDAR odometry 220, the LiDAR odometry 220 may be information set as a default value or may be generated in advance according to a predetermined method different from the estimation method to be described later.

The position and heading direction (x, y, θ) of the moving object 20 at each point in time are included in the LiDAR odometry 220 information, and among them, the heading direction may be projected onto the center of the grid 311. The projected heading direction may be the last heading direction or an average heading direction.

In FIG. 3, the 2D submap 310 includes a plurality of grids 311 and is composed of projected scan data 312 that are projected onto the grids 311.

In step S120, the apparatus 10 for estimating LiDAR odometry and covariance of the moving object 20 according to an exemplary embodiment of the present invention (more precisely, a submap module 820 of the apparatus 10 for estimating LiDAR odometry and covariance of the moving object 20) generates a 2D NDT submap based on the 2D submap using a Normal Distribution Transform (NDT) method.

NDT is one method of scan registration or scan matching. Unlike the point-to-point matching method that directly matches measured scan points with reference scan points, this method models the reference scan points as a linear combination of normal distributions and calculates the likelihood of the measured scan points. Since the reference scan is represented as a linear combination of normal distributions, it is piece-wise continuous, and its first-order derivatives and second-order derivatives are continuous, so it is common to obtain an optimal solution using methods such as Newton's method.

Although the present invention describes exemplary embodiments using a 2D NDT submap, the present invention may utilize various types of submaps including a 3D NDT submap. For example, 3D NDT according to an exemplary embodiment of the present invention may construct a more detailed and in-depth submap by providing 3D visualization.

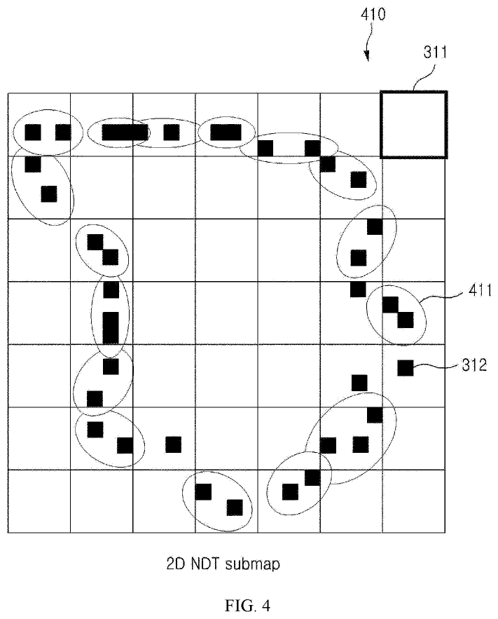

In step S120, the apparatus of the present invention may generate a 2D NDT submap by calculating a set of normal distributions within each of the plurality of grids. More specifically, referring to FIG. 4, in step S120, the apparatus of the present invention may generate a normal distribution by calculating a mean and a covariance of the positions of projected scan data 312 within each of the plurality of grids 311 forming the 2D submap, and generate a 2D NDT submap 410 including a set of normal distributions 411 based on the generated normal distributions. In this case, since the calculation involves variance, a normal distribution can be generated only for grids 311 in which two or more projected scan data 312 are present.

In step S130, the apparatus 10 for estimating LiDAR odometry and covariance of the moving object 20 according to an exemplary embodiment of the present invention (more precisely, a LiDAR Odometry estimation module 830 of the apparatus 10 for estimating LiDAR odometry and covariance of the moving object 20) estimates the LiDAR odometry of the moving object 20 by performing scan matching based on Particle Swarm Optimization (PSO) between the 2D NDT submap and scan data detected in real time by the LiDAR. PSO is a meta-heuristic optimization method. In this method, particles having the same dimensionality as the search space exchange information about their optimal solutions with one another to find a global optimum. Accordingly, it is an optimization method that involves relatively high computational load but is capable of finding a global optimum.

In step S130, the apparatus of the present invention may perform NDT scan matching based on Particle Swarm Optimization (PSO) to obtain an optimal transformation in which the scan data detected in real time by the LiDAR has a minimum distance with respect to the set of normal distributions constituting the 2D NDT submap.

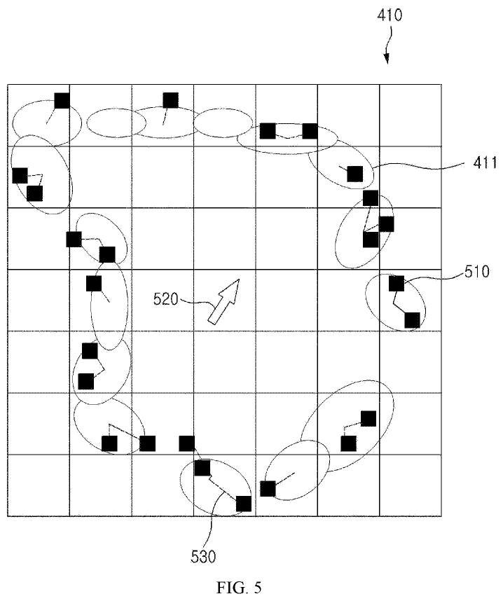

More specifically, referring to FIG. 5, in step S130, the apparatus of the present invention projects scan data 510 detected in real time from an initial guess 520 of the pose of the moving object 20 onto the grids 311 of the 2D NDT submap 410, and scores the distance 530 to the set of normal distributions 411 of the 2D NDT submap 410 using [Mathematical Equation 1] below.

$$score = {\sum }_{i ∈ G} {\sum }_{p ∈ {P}_{i}} {e}^{- \frac{1}{2} {( p - {μ}_{i} )}^{T} {\sum }_{i}^{- 1} ( p - {μ}_{i} )} \qquad [ Mathematical Equation 1 ]$$

Where, G represents the entire grid, Pi denotes the set of two-dimensional positions (x, y) of real-time scan data projected onto the i-th grid, μᵢ represents the mean of the normal distribution of the i-th grid, and Ei represents the covariance of the normal distribution of the i-th grid.

The scan data 510 is transformed by an arbitrary transformation R|t, and a score with respect to the 2D NDT submap 410 is calculated. The score approaches 1 when the scan data 510 is closer to the 2D NDT submap 410 for each individual scan point, and approaches 0 when it is farther away; accordingly, in step S130, the apparatus of the present invention performs optimization with the objective of maximizing the score.

An arbitrary transformation R|t in a two-dimensional space may be divided into a two-dimensional translational transformation and a one-dimensional rotational transformation, and may be represented as (tₓ, t_{y}, R_{θ}). To obtain an optimal (tₓ, t_{y}, R_{θ}) that maximizes the score, in step S130, the apparatus of the present invention performs optimization using a Particle Swarm Optimization (PSO) method within the three-dimensional solution set.

The particles within the swarm have different random values of (tₓ, t_{y}, R_{θ}), and in step S130, the apparatus of the present invention determines a matching score between the scan data and the 2D NDT submap 410 based on the values of the particles in the swarm. Subsequently, the value of each particle is updated through the process described in [Mathematical Equation 2] below.

$${V}_{n} ( t + 1 ) = {w}_{i} \times {V}_{n} ( t ) + {w}_{c} R ( {pbest}_{n} - {X}_{n} ( t ) ) + {w}_{s} R ( gbest - {X}_{n} ( t ) ) \qquad [ Mathematical Equation 2 ]$$

$${X}_{n} ( t + 1 ) = {X}_{n} ( t ) + {V}_{n} ( t + 1 )$$

Where, Xn(t) represents the value (tₓ, t_{y}, R_{θ}) of the n-th particle at the t-th iteration, and Vn(t+1) indicates the degree of update of Xn(t) between the t-th and (t+1)th iterations. In addition, wᵢ denotes the inertia coefficient, w_{c} denotes the cognitive learning coefficient, and denotes the social learning coefficient. In addition, R represents a random real number in the range of [0, 1]. In addition, pbestn represents the optimal value (tₓ, t_{y}, R_{θ})) experienced by the n-th particle during the iterations, and gbest represents the optimal value (tₓ, t_{y}, R_{θ}) experienced by the swarm during the t-th iteration.

When the scan matching is completed through step S130, the position and orientation of the moving object 20 detected in real time can be estimated.

In step S140, the apparatus 10 for estimating LiDAR odometry and covariance of the moving object 20 according to an exemplary embodiment of the present invention (more precisely, a LiDAR Odometry estimation module 830 of the apparatus 10 for estimating LiDAR odometry and covariance of the moving object 20) determines whether the LiDAR odometry and scan data, which are obtained through PSO-based NDT scan matching in step S130, correspond to a keyframe. Accordingly, in step S140, when the LiDAR odometry and scan data obtained through PSO-based NDT scan matching correspond to a keyframe, the apparatus of the present invention may add the scan data and LiDAR odometry, which are obtained as the keyframe, to a local window (step S150).

Referring to FIG. 6, more specifically, in steps S140 and S150, when the LiDAR odometry and scan data obtained through PSO-based NDT scan matching correspond to a keyframe, the apparatus of the present invention adds the corresponding scan data 611 and LiDAR odometry 621 to a local window 230, and removes the oldest pair of scan data 612 and LiDAR odometry 622 from the local window 230 in order to maintain the size of the local window 230, that is, to maintain a predetermined number.

Referring back to FIG. 1, in step S160, the apparatus 10 for estimating LiDAR odometry and covariance of the moving object 20 according to an exemplary embodiment of the present invention (more precisely, a covariance determination module 840 of the apparatus 10 for estimating LiDAR odometry and covariance of the moving object 20) represents the normal distribution of the grids in the 2D NDT submap using eigenvectors, and determines the covariance of the LiDAR odometry by calculating the ratio of the grids having eigenvectors similar to the real-time pose of the moving object 20.

The covariance of the LiDAR odometry is related to the reliability or error associated with the position and angle of the moving object 20. The covariance of the LiDAR odometry may be a preset value. The covariance may be stored in the memory 800 according to preset values, including at least a high covariance and a low covariance.

More specifically, in step S160, the apparatus of the present invention represents the normal distribution of each grid in the 2D NDT submap as a pair of eigenvectors, and selects the eigenvector with the greatest magnitude among them as the dominant eigenvector of the corresponding grid.

Subsequently, the apparatus of the present invention determines the covariance of the LiDAR odometry by calculating the ratio of the grids whose dominant eigenvectors are similar to the real-time pose of the moving object 20 (that is, the heading direction expressed as an angle). If the absolute value of the angular difference between the direction (theta) of the dominant eigenvector of a grid and the direction (theta) of the moving object 20 estimated by the LiDAR odometry is within a preset angle, it may be determined that the two directions are similar. For example, the preset angle may be 10 degrees.

The reason for selecting the dominant eigenvector is that, in general, when LiDAR data represents indoor walls, it forms a linear shape in a two-dimensional coordinate system, and the shape of the normal distribution within a grid becomes an ellipse biased in one direction. Accordingly, the dominant eigenvector represents the representative direction of the surrounding object distribution, and the greater the number of grids having the same direction, the more likely it is that the moving object 20 is in an environment such as a long corridor. Since a pair of eigenvectors are orthogonal to each other, the similarity between the arrangement of surrounding objects and the direction of movement can be indirectly determined regardless of the magnitudes of the eigenvectors. However, in order to select the vector whose direction is similar to the movement direction of the moving object 20, the eigenvector with the greater magnitude is selected as the dominant eigenvector.

In step S160, the apparatus of the present invention represents the normal distribution set 411 of a plurality of grids within the 2D NDT submap 410 as two-dimensional eigenvectors, and selects the dominant eigenvector among the two eigenvectors representing each normal distribution as a representative eigenvector 710. Accordingly, in step S160, the apparatus of the present invention calculates a grid ratio 720 in which the selected representative eigenvector 710 is similar to the real-time pose 730 of the moving object 20, and compares the calculated grid ratio 720 with a preset threshold value Th (step S170).

In step S170, if the grid ratio 720 exceeds the preset threshold value, the apparatus of the present invention determines the covariance of the LiDAR odometry of the moving object 20 to be large (i.e., a high covariance 181), and if the grid ratio 720 is less than or equal to the preset threshold value, the apparatus may determine the covariance of the LiDAR odometry of the moving object 20 to be small (i.e., a low covariance 182).

The fact that the grid ratio 720 exceeds the preset threshold value may indicate that the geometric structure of the environment surrounding the moving object 20 is relatively simple. In this case, the apparatus of the present invention may determine the covariance of the LiDAR odometry to be a high value. Such processing may reduce the reliability of the position and orientation of the moving object 20, thereby lowering the contribution of the odometry information in localization or control of the moving object 20, or triggering a request for more precise exploration.

Conversely, the fact that the grid ratio 720 is less than or equal to the preset threshold value may indicate that the geometric structure of the environment surrounding the moving object 20 is relatively complex. In this case, the apparatus of the present invention may determine the covariance of the LiDAR odometry to be a low value. Such processing may increase the reliability of the surrounding environment, thereby increasing the contribution of the odometry information in localization or control of the moving object 20, or triggering a control request to reduce other power used for exploration.

In step S190, the apparatus 10 for estimating LiDAR odometry and covariance of the moving object 20 according to an exemplary embodiment of the present invention (more precisely, a covariance determination module 840 of the apparatus 10 for estimating LiDAR odometry and covariance of the moving object 20) may incorporate the covariance into the LiDAR odometry information, and output the real-time LiDAR odometry of the moving object 20 including the covariance.

Outputting the LiDAR odometry may mean providing the LiDAR odometry including the covariance to another computing device or to a control unit of the moving object 20 so that it can be used for controlling the movement of the moving object 20.

Outputting the LiDAR odometry may also mean that the processor 850 uses the LiDAR odometry information in combination with odometry information obtained from other detection means and/or algorithms to recognize the surrounding environment. The combination of different odometry information may be performed using various methods, such as weighted combination or filtering-based combination.

In step S190, the apparatus of the present invention may output a result value of the LiDAR odometry by combining the LiDAR odometry obtained through PSO-based NDT scan matching in step S130 with the covariance obtained in step S160.

FIG. 8 is a block diagram illustrating a detailed configuration of an apparatus 10 for estimating LiDAR odometry and covariance of a moving object 20 according to an exemplary embodiment of the present invention.

Referring to FIG. 8, the apparatus 10 for estimating LiDAR odometry and covariance of the moving object 20 according to an exemplary embodiment of the present invention estimates the LiDAR odometry of the moving object 20 using NDT-PSO and estimates the covariance of the LiDAR odometry.

To this end, the apparatus 10 for estimating LiDAR odometry and covariance of the moving object 20 according to an exemplary embodiment of the present invention includes a processor 850 and a memory 800.

The processor 850 may use information stored in the memory 800, execute instructions, and control the moving object 20. The processor that controls the moving object 20 may be physically separated from the apparatus. In this case, the processor 850 may estimate the LiDAR odometry information and then provide it to a processor installed in the moving object 20.

In the description of the present invention, for the sake of convenience, the execution of a module stored in the memory 800 by the processor 850 may be described with the module as the subject.

The memory 800 stores at least one instruction, and a plurality of instructions may be stored in a modularized form. The memory 800 includes a local window module 810, a submap module 820, a LiDAR Odometry estimation module 830, and a covariance determination module 840.

The local window module 810 constructs a local window using scan data detected by the LiDAR mounted on the moving object 20 and the LiDAR odometry.

The local window module 810 may construct a local window by combining scan data of a preset number of keyframes among scan data detected by the LiDAR mounted on the moving object 20 with LiDAR odometry at each point in time from the scan data of the keyframes. Here, the scan data may be 2D scan data.

The submap module 820 generates a 2D submap using the local window and configures the 2D submap as a 2D NDT submap based on a Normal Distribution Transform (NDT) method.

The submap module 820 may generate a 2D submap by projecting the scan data of the keyframes within the local window onto a grid area based on the pose represented by the LiDAR odometry at each time point. Subsequently, the submap module 820 may generate a normal distribution for each of a plurality of grids constituting the 2D submap by calculating the mean and covariance of the positions of the scan data within each grid, and may generate a 2D NDT submap using the generated normal distributions.

The LiDAR Odometry estimation module 830 estimates the LiDAR odometry of the moving object 20 by performing scan matching based on Particle Swarm Optimization (PSO) between the 2D NDT submap and the scan data detected in real time by the LiDAR.

The LiDAR Odometry estimation module 830 may perform NDT scan matching based on Particle Swarm Optimization (PSO) to obtain an optimal transformation in which the scan data detected in real time by the LiDAR has a minimum distance with respect to the set of normal distributions constituting the 2D NDT submap.

Subsequently, the LiDAR Odometry estimation module 830 determines whether the LiDAR odometry and scan data obtained through PSO-based NDT scan matching correspond to a keyframe. Accordingly, when the LiDAR odometry and scan data obtained through PSO-based NDT scan matching correspond to a keyframe, the LiDAR Odometry estimation module 830 may add the scan data and LiDAR odometry, which are obtained as the keyframe, to a local window.

The covariance determination module 840 represents the normal distribution of the grids in the 2D NDT submap as eigenvectors, calculates the ratio of the grids having eigenvectors similar to the real-time pose of the moving object 20, and determines the covariance of the LiDAR odometry.

More specifically, the covariance determination module 840 represents the normal distribution of each grid in the 2D NDT submap as a pair of eigenvectors, and selects the eigenvector with the greatest magnitude among them as the dominant eigenvector of the corresponding grid. Subsequently, the apparatus of the present invention determines the covariance of the LiDAR odometry by calculating the ratio of the grids whose dominant eigenvectors are similar to the real-time pose of the moving object 20. Here, the term “similar” as used in the present invention refers to a value in which the absolute difference between the direction (theta) of the dominant eigenvector of a grid and the direction (theta) of the moving object 20 estimated by the LiDAR odometry is within 10 degrees.

The reason for selecting the dominant eigenvector is that, in general, when LiDAR data represents indoor walls, it forms a linear shape in a two-dimensional coordinate system, and the shape of the normal distribution within a grid becomes an ellipse biased in one direction. Accordingly, the dominant eigenvector represents the representative direction of the distribution, and the greater the number of grids having the same direction, the more likely it is that the moving object 20 is in an environment such as a long corridor. Since a pair of eigenvectors are orthogonal to each other, their effect is the same regardless of their magnitude. However, the eigenvector with the greater magnitude is selected as the dominant eigenvector in order to choose the vector whose direction is similar to the movement direction of the moving object 20.

The covariance determination module 840 represents the set of normal distributions of a plurality of grids in the 2D NDT submap as two-dimensional eigenvectors, and selects the dominant eigenvector among the two eigenvectors representing each normal distribution as a representative eigenvector. Accordingly, the covariance determination module 840 calculates the ratio of the grids whose selected representative eigenvectors are similar to the real-time pose of the moving object 20, and compares the calculated grid ratio with a predetermined threshold value Th.

The covariance determination module 840 may assign the covariance of the LiDAR odometry of the moving object 20 to be greater than a predetermined value (i.e., a high covariance) when the grid ratio exceeds the predetermined threshold value, and may assign the covariance of the LiDAR odometry of the moving object 20 to be smaller than the predetermined value (i.e., a low covariance) when the grid ratio is less than or equal to the predetermined threshold value. At this time, if the grid ratio exceeds the predetermined threshold value, the environment surrounding the moving object 20 is recognized as an environment with less geometric structure, and the covariance of the LiDAR odometry is assigned to be high. If the grid ratio is less than or equal to the predetermined threshold value, the environment surrounding the moving object 20 is recognized as an environment with more diverse geometric structure, and the covariance of the LiDAR odometry is assigned to be low.

Subsequently, the covariance determination module 840 may output the real-time LiDAR odometry of the moving object 20 by fusing the LiDAR odometry with the covariance. The covariance determination module 840 may output a result value of the LiDAR odometry by combining the LiDAR odometry obtained through PSO-based NDT scan matching with the calculated covariance.

Although the description is omitted in the system of FIG. 8, each constituent means forming FIG. 8 may include all the elements described in FIGS. 1 to 7, which is apparent to those skilled in the art.

The system or apparatus described above may be implemented as hardware components, software components, and/or a combination of hardware and software components. For example, the apparatuses and components described in the embodiments may be implemented using one or more general-purpose or special-purpose computers, such as a processor, controller, arithmetic logic unit (ALU), digital signal processor (DSP), microcomputer, field programmable gate array (FPGA), programmable logic unit (PLU), microprocessor, or any other device capable of executing and responding to instructions. The processing device may execute an operating system (OS) and one or more software applications running on the operating system. In addition, the processing device may access, store, manipulate, process, and generate data in response to the execution of software. For convenience of understanding, a single processing device may be described as being used; however, those skilled in the art will understand that the processing device may include a plurality of processing elements and/or a plurality of types of processing elements. For example, the processing device may include a plurality of processors or a single processor and a controller. In addition, other processing configurations, such as a parallel processor, are also possible.

The software may include a computer program, code, instructions, or any combination thereof, and may configure the processing device to operate as desired or instruct the processing device either independently or collectively. The software and/or data may be embodied, either permanently or temporarily, in any type of machine, component, physical device, virtual equipment, computer-readable storage medium or device, or transmitted signal wave, to be interpreted by the processing device or to provide instructions or data to the processing device. The software may be distributed across network-connected computer systems and may be stored or executed in a distributed manner. The software and data may be stored on one or more computer-readable recording media.

The method according to the embodiment may be implemented in the form of program instructions that can be executed by various computer means and may be recorded on a computer-readable medium. The computer-readable medium may include program instructions, data files, data structures, etc. alone or in combination thereof. The program instructions recorded on the medium may be those specially designed and configured for the embodiments, or they may be known and available to those skilled in the field of computer software. Examples of computer-readable recording media include hardware devices specially configured to store and execute program instructions, such as hard disks, magneto-optical media, solid-state drives (SSDs), and read-only memory (ROM), random access memory (RAM), and flash memory. Examples of program instructions include not only machine language codes such as those generated by a compiler, but also high-level language codes that can be executed by a computer using an interpreter or the like. The above-described hardware devices may be configured to operate as one or more software modules to perform the operations of the embodiment, and vice versa.

Although the embodiments have been described by limited examples and drawings, those skilled in the art will appreciate that various modifications and variations can be made from the above description. For example, suitable results may be achieved even if the described techniques are performed in a different order than described, and/or components of the described systems, structures, devices, circuits, etc. are coupled or combined in a different manner than described, or are replaced or substituted by other components or equivalents.

Therefore, other implementations, other embodiments, and equivalents to the claims are also within the scope of the following claims.

What is claimed is:

1. A method for estimating LiDAR odometry and covariance of a moving robot, performed by a computer, comprising:
constructing a two-dimensional (2D) Normal Distribution Transform (NDT) submap by applying NDT to a 2D submap;
estimating the LiDAR odometry of the moving robot using the 2D NDT submap; and
calculating at least one eigenvector of a normal distribution of a grid within the 2D NDT submap, extracting a grid having an eigenvector corresponding to a real-time pose of the moving robot, and determining a covariance of the LiDAR odometry;
wherein the method further comprises constructing a local window using scan data detected by a LiDAR mounted on the moving robot and the LiDAR odometry,
wherein the constructing the local window comprises:
constructing the local window by combining scan data of a preset number of keyframes among the scan data detected by the LiDAR mounted on the moving robot and the LiDAR odometry at each time point corresponding to the scan data of the keyframes, and
wherein the constructing the 2D NDT submap is projecting the scan data of the keyframes within the local window onto grids based on poses represented by the LiDAR odometry at each time point, comprises:
generating a normal distribution by calculating a mean and a covariance of the positions of the scan data within each of a plurality of grids forming the 2D submap; and
generating the 2D NDT submap using the generated normal distributions.

2. The method of claim 1, wherein the constructing the 2D NDT submap comprises:
generating a normal distribution only for grids in which two or more scan data are present.

3. The method of claim 1, wherein estimating LiDAR odometry of the moving object comprises:
performing NDT scan matching based on Particle Swarm Optimization (PSO) to obtain an optimal transformation in which scan data detected in real time by the LiDAR has a minimum distance with respect to a set of normal distributions constituting the 2D NDT submap.

4. The method of claim 3, wherein
estimating the LiDAR odometry of the moving robot comprises:
when the LiDAR odometry and scan data obtained through the PSO-based NDT scan matching correspond to a keyframe, adding the scan data and the LiDAR odometry obtained as the keyframe to the local window.

5. The method of claim 1, wherein the determining the covariance of the LiDAR odometry comprises:
calculating a ratio of grids having an eigenvector corresponding to a real-time pose of the moving object among two eigenvectors representing a normal distribution of a grid within the 2D NDT submap.

6. The method of claim 5, wherein the determining the covariance of the LiDAR odometry comprises:
assigning the covariance of the LiDAR odometry of the moving robot to be greater than a predetermined value when the ratio of the grids exceeds a threshold value, and assigning the covariance to be less than the predetermined value when the ratio of the grids is less than or equal to the threshold value.

7. The method of claim 5, wherein the determining the covariance of the LiDAR odometry comprises:
outputting real-time LiDAR odometry of the moving robot by fusing the LiDAR odometry with the covariance.

8. An apparatus for estimating LiDAR odometry and covariance of a moving robot, comprising:
a submap module configured to construct a two-dimensional (2D) Normal Distribution Transform (NDT) submap by applying NDT to a 2D submap;
a LiDAR Odometry estimation module configured to estimate the LiDAR odometry of the moving robot using the 2D NDT submap;
a covariance determination module configured to calculate at least one eigenvector of a normal distribution of a grid within the 2D NDT submap, extract a grid having an eigenvector corresponding to a real-time pose of the moving robot, and determine a covariance of the LiDAR odometry; and
a local window module configured to construct a local window using scan data detected by a LiDAR mounted on the moving robot and the LiDAR odometry;
wherein the local window module is configured to construct the local window by combining scan data of a preset number of keyframes among the scan data detected by the LiDAR mounted on the moving robot and the LiDAR odometry at each time point corresponding to the scan data of the keyframes, and
wherein the submap module is configured to project the scan data of the keyframes within the local window onto grids based on poses represented by the LiDAR odometry at each time point, to generate a normal distribution by calculating a mean and a covariance of positions of the scan data within each of a plurality of grids forming the 2D submap, and to generate the 2D NDT submap using the generated normal distributions.

9. The apparatus of claim 8, wherein the LiDAR Odometry estimation module is configured to perform NDT scan matching based on Particle Swarm Optimization (PSO) to obtain an optimal transformation in which scan data detected in real time by the LiDAR has a minimum distance with respect to a set of normal distributions constituting the 2D NDT submap.

10. The apparatus of claim 9, wherein the LiDAR Odometry estimation module is configured to, when the LiDAR odometry and scan data obtained through the PSO-based NDT scan matching correspond to a keyframe, add the scan data and the LiDAR odometry obtained as the keyframe to the local window.

11. The apparatus of claim 8, wherein the covariance determination module is configured to calculate a ratio of grids having an eigenvector corresponding to a real-time pose of the moving object among two eigenvectors representing a normal distribution of a grid within the 2D NDT submap.

12. The apparatus of claim 11, wherein
the covariance determination module is configured to assign the covariance of the LiDAR odometry of the moving robot to be greater than a predetermined value when the ratio of the grids exceeds a threshold value, and to assign the covariance to be less than the predetermined value when the ratio of the grids is less than or equal to the threshold value.

13. The apparatus of claim 11, wherein
the covariance determination module is configured to output real-time LiDAR odometry of the moving robot by fusing the LiDAR odometry with the covariance.
